(19) United States
(12) Patent Application Publication
(10) Pub. No.: US 2018/0375282 A1
(43) Pub. Date: Dec. 27, 2018

(54) TWO-DIMENSIONAL SEMICONDUCTOR SATURABLE ABSORBER MIRROR AND FABRICATION METHOD, AND PULSE FIBER LASER

(71) Applicant: Shenzhen University, SHENZHEN (CN)

(72) Inventors: Peiguang YAN, SHENZHEN (CN); Hao CHEN, SHENZHEN (CN); Fengfei XING, SHENZHEN (CN); Jinfei DING, SHENZHEN (CN)

(21) Appl. No.: 16/052,621

(22) Filed: Aug. 2, 2018

Related U.S. Application Data
(63) Continuation of application No. PCT/CN2016/085986, filed on Jun. 16, 2016.

(51) Int. Cl. H01S 3/11; H01S 3/067; H01S 3/094

(52) U.S. Cl. CPC H01S 3/1118; H01S 3/094003; H01S 3/0675

(57) ABSTRACT

A two-dimensional semiconductor saturable absorber mirror comprises an optical fiber, a two-dimensional semiconductor thin film attached to an end surface of the optical fiber, and a gold film attached to the two-dimensional semiconductor thin film. A method for fabricating the two-dimensional semiconductor saturable absorber mirror comprises the following steps: cutting the optical fiber, putting the cut optical fiber and a two-dimensional semiconductor target into a vacuum chamber, ionizing a surface of two-dimensional semiconductor target to generate two-dimensional semiconductor plasma, depositing the two-dimensional semiconductor plasma on an exposed end surface of the optical fiber to form the two-dimensional semiconductor thin film, and by controlling deposition time and/or deposition temperature, ensuring the two-dimensional semiconductor thin film to be a desired thickness; and plating the gold film on the resulting two-dimensional semi-conductor thin film.

### CROSS-REFERENCE TO RELATED APPLICATIONS

This application is a continuation of International Patent Application No. PCT/CN2016/085986 with a filing date of Jun. 16, 2016, designating the United States, now pending. The content of the aforementioned applications, including any intervening amendments thereto, are incorporated herein by reference.

### TECHNICAL FIELD

The present invention relates to the technical field of lasers, and more particularly to a two-dimensional semiconductor saturable absorber mirror and a fabrication method therefor, and a pulse fiber laser.

### BACKGROUND OF THE PRESENT INVENTION

Passive mode locking is an effective way for fiber laser to realize ultrafast pulse output, and the key technique of passive mode-locking is the saturable absorption effect required in the resonator of the fiber laser. Researchers in the art have obtained passive mode-locking ultrafast pulse output in fiber lasers by using a variety of saturable absorption effects. Generally speaking, in order to overcome the instability of locking environment in the fiber laser, the researchers usually use the semiconductor saturable absorber mirror (SESAM) to realize the mode-locking ultrafast pulse output from the fiber laser. However, commercial SESAM is not suitable for the study on dynamic characteristics of ultrafast fiber laser due to its high price, complex fabrication process, narrow absorption bandwidth, output of only picosecond pulse and low damage threshold. Therefore, a low-cost, simple and high-performance saturable absorber has been the object in the ultrafast laser physics field for a long time.

### SUMMARY OF PRESENT INVENTION

The technical problem to be solved in the present invention is to provide a two-dimensional semiconductor absorber mirror, a fabrication method therefor and a pulse fiber laser, which can overcome the disadvantages of expensive price, complex manufacturing process, low reliability, and narrow operational bandwidth of existed commercial SESAM.

In one aspect, a two-dimensional semiconductor saturable absorber mirror is provided, which comprises an optical fiber, a two-dimensional semiconductor thin film attached to an end surface of the optical fiber, and a gold film attached to the two-dimensional semiconductor thin film.

In another aspect, a method for fabricating the two-dimensional semiconductor saturable absorber mirror is provided, which comprises the following steps: cutting the optical fiber; putting the cut optical fiber and a two-dimensional semiconductor target into a vacuum chamber, ionizing a surface of two-dimensional semiconductor target to generate two-dimensional semiconductor plasma, depositing the two-dimensional semiconductor plasma on an exposed end surface of the optical fiber to form the two-dimensional semiconductor thin film, and by controlling deposition time and/or deposition temperature, ensuring the two-dimensional semiconductor thin film to be a desired thickness; and plating the gold film on the resulting two-dimensional semi-conductor thin film.

In yet another aspect, a pulse fiber laser is provided, which comprises a semiconductor pump laser, an optical coupler, and a resonant cavity; pump light produced by the semiconductor pump laser enters the resonant cavity through the optical coupler, the aforementioned two-dimensional semiconductor saturable absorber mirror is provided in the resonant cavity, and the two-dimensional semiconductor saturable absorber mirror is configured to modulate the light in the resonant cavity to produce pulse laser.

The advantages are as follows. The two-dimensional semiconductor saturable absorber mirror provided in the disclosure includes an end surface of optical fiber, a two-dimensional semiconductor thin film and a gold film. It has a high damage threshold and is difficult to be damaged when used. It can be prepared in batch, so it is low in cost and suitable to be widely used. At the same time, it can be directly fused to the fiber laser system since it can be integrated on the end surface of the fiber; therefore it is easy to use and has high reliability. With these characteristics, the pulse fiber laser made of the two-dimensional semiconductor saturable absorber mirror has the advantages of full utilization of fiber and high reliability. The pulse fiber laser can be used as the source of the amplifier, and it is easy to be made into product, and also easy for achievements transformation.

### DESCRIPTION OF THE DRAWINGS

FIG. 1 is a structural schematic diagram of a two-dimensional semiconductor saturable absorber mirror according to the embodiments of the present disclosure;

FIG. 2 is a flow diagram of a method for manufacturing the two-dimensional semiconductor saturable absorber mirror according to the embodiments of the present disclosure;

FIG. 3 is a structural schematic diagram of a pulse fiber laser according to the embodiments of the present disclosure; and

FIG. 4 is a structural schematic diagram of another pulse fiber laser with self-amplifying function according to the embodiments of the present disclosure.

### DETAILED DESCRIPTION OF PREFERRED EMBODIMENTS

In order to make the objects, the technical solutions and the advantages of the present invention more clear and be better understood, the disclosure will be described in detail with reference to the accompanying drawings and embodiments.

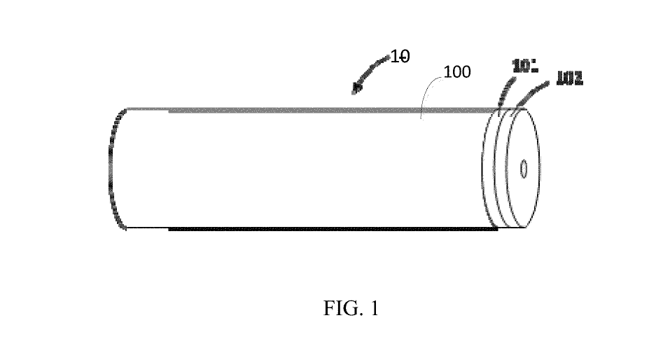

Referring to FIG. 1, a two-dimensional semiconductor saturable absorber mirror 10 is provided in the present disclosure. The two-dimensional semiconductor saturable absorber mirror 10 comprises an optical fiber 100, a two-dimensional semiconductor thin film 101 attached to an end surface of the optical fiber, and a high-reflecting film 102 attached to the two-dimensional semiconductor thin film 101. The optical fiber can be a single-mode fiber, a polarization-maintaining fiber, a high-gain active optical fiber (erbium-doped fiber, ytterbium-doped fiber, thulium-doped fiber, holmium-doped fiber, praseodymium-doped fiber, bismuth-doped fiber), or an active ZBLAN fiber.

The two-dimensional semiconductor thin film 101 can be made of any of copper sulfide, black phosphorus, gallium selenide, gallium telluride, gallium sulfide, germanium selenide, tungsten ditelluride, molybdenum ditelluride, hafnium disulfide, hafnium diselenide, cobalt diselenide, cobalt ditelluride, rhenium diselenide, rhenium ditelluride, tin disulfide, tin diselenide, niobium disulfide, niobium diselenide, titanium disulfide, titanium diselenium, tantalum disulfide, tantalum diselenide, zirconium disulfide, zirconium ditelluride, bismuth sulfide, bismuth selenide, and bismuth telluride. Alternatively, the two-dimensional semiconductor thin film can be a heterojunction superlattice with any two above materials alternatively growing.

The high-reflecting film 102 is a gold film with extremely high reflectance, the thickness of the gold film is not less than 500 nm, and preferably 500-1000 nm. The high-reflecting film 102 is acted as a high-reflecting mirror, and it's used to prevent the two-dimensional semiconductor thin film from being oxidized by the oxygen and corroded by the vapor in the air, thus offering protection.

The two-dimensional semiconductor saturable absorber mirror 10 is functioned as a high-reflecting mirror in the laser for modulating. The Q-switching or mode locking can be realized since the laser in the resonant cavity is modulated by the two-dimensional semiconductor saturable absorber mirror 10 when reflected. This kind of two-dimensional semiconductor saturable absorber mirror 10 has a high damage threshold, and it can provide broadband modulation to light and act as a reflecting mirror in the same time, so it is a critical device for producing pulse laser in the laser system.

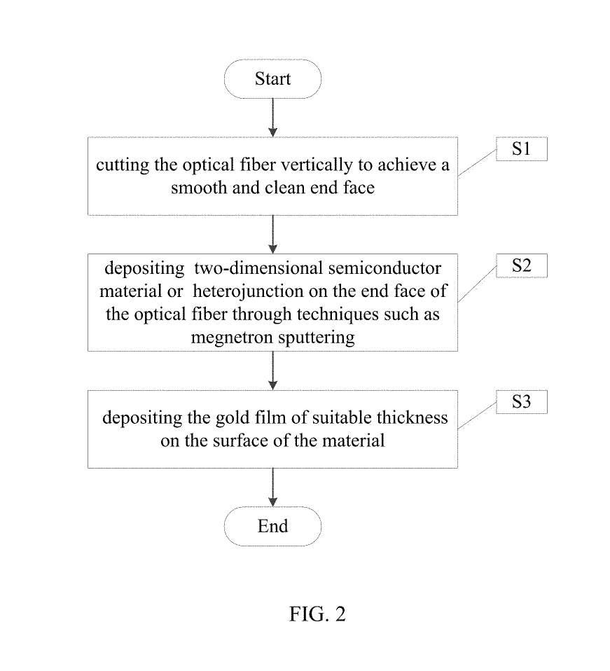

Referring to FIG. 2, a method for manufacturing the two-dimensional semiconductor saturable absorber mirror is provided according to the embodiments of the present disclosure, which comprises the following steps:

S1: cutting the optical fiber vertically to achieve a smooth and clean end surface of the optical fiber;

S2: putting the cut optical fiber and a two-dimensional semiconductor target into a vacuum chamber, ionizing the surface of the two-dimensional semiconductor target to produce two-dimensional semiconductor plasma, depositing the two-dimensional semiconductor plasma on the end surface of the optical fiber to form the two-dimensional semiconductor thin film, and by controlling the deposition time and/or deposition temperature, ensuring the two-dimensional semiconductor thin film reach a desired thickness; and

S3: plating the gold film on the resulted two-dimensional semi-conductor thin film.

Specifically, in step S1, an optical fiber cutter can be used and it should be ensured that the end surface of the optical fiber is smooth.

Specifically, in step S2, the process of plating the two-dimensional semiconductor thin film on the optical fiber comprises putting the cut optical fiber and the two-dimensional semiconductor target at the alternating-current (AC) target position in the vacuum chamber. The end surface of the optical fiber should be kept aimed at the two-dimensional semiconductor target, in order to ensure the ionized two-dimensional semiconductor plasma is well deposited on the end surface of the optical fiber. The surface of the two-dimensional semiconductor target is ionized to produce two-dimensional semiconductor plasma, and the two-dimensional semiconductor plasma is deposited on the end surface of the optical fiber to form the two-dimensional semiconductor thin film.

Specifically, in step S3, a gold target is put at a direct-current (DC) target position deposit in the vacuum chamber when plating the gold film on the resulted two-dimensional semi-conductor thin film.

Specifically, in step S2, the surface of the two-dimensional semiconductor target is ionized to form plasma by magnetron sputtering or pulsed radiofrequency deposition, and the plasma is deposited on the end surface of the optical fiber to form the two-dimensional semiconductor thin film. In the deposition, the thickness of the deposited two-dimensional semiconductor thin film can be controlled by adjusting the parameters such as the deposition time, the deposition temperature and so on. Or any two abovementioned materials can be chosen to grow alternatively to form the heterojunction superlattice.

The fabrication method of the two-dimensional semiconductor saturable absorber mirror provided in the present disclosure utilizes the magnetron sputtering method or the pulse radiofrequency deposition method, which is simple and suitable for mass production. During the deposition, the thickness and uniformity of the two dimensional semiconductor thin film can be controlled by adjusting the deposition temperature and time, so it can be used in mass production and make the two-dimensional semiconductor saturable absorber mirrors made in accordance with the same specification, and the bandwidth of the prepared two-dimensional semiconductor saturable absorber mirror can be expanded from the visible light to the infrared light. The prepared two-dimensional semiconductor saturable absorber mirror includes an end surface of optical fiber, a two-dimensional semiconductor thin film and a gold film. It has a high damage threshold and is difficult to be damaged when used. It can be prepared in batch, so it is low in cost and suitable to be widely used. At the same time, it can be directly fused to the fiber laser system since it can be integrated on the end surface of the fiber; therefore it is easy to use and has high reliability. With these characteristics, the pulse fiber laser made of the two dimensional semiconductor saturable absorber mirror has the advantages of full utilization of fiber and high reliability. The pulse fiber laser can be used as the source of the amplifier with a pulse amplifier, and it is easy to be made into product, and also easy for achievements transformation.

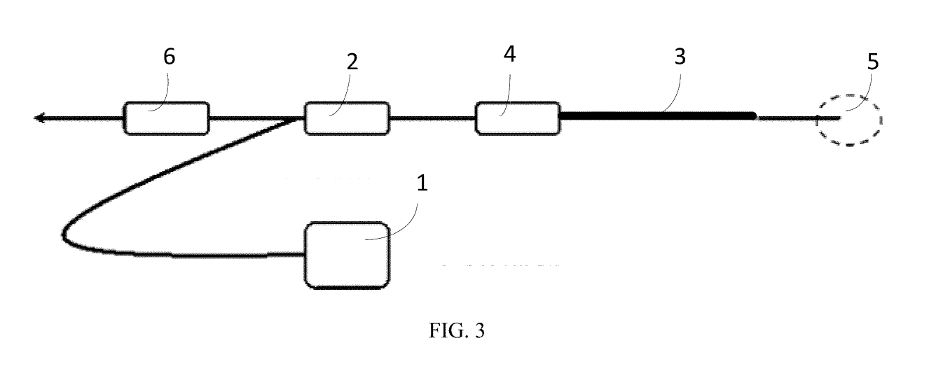

Referring to FIG. 3, a pulse fiber laser is provided according to the embodiments of the present disclosure, which has a linear cavity structure. It comprises a semiconductor pump laser 1, an optical coupler 2, and a resonant cavity. The resonant cavity comprises a high-gain active optical fiber 3, an optical fiber grating 4, the two-dimensional semiconductor saturable absorber mirror 5 manufactured through above method, and an optical isolator 6. The optical coupler 2 may be a wavelength division multiplexer.

The operational principle of the pulse fiber laser is as follows. The pump light produced by the semiconductor pump laser 1 enters the resonant cavity through the optical coupler 2 to provide gain to the active optical fiber 3, and laser light is hence produced by the resonation of the resonant cavity. Then the laser light is modulated by the two-dimensional semiconductor saturable absorber mirror 5 to produce the pulse laser. Specifically, the saturable absorber mirror 5 are capable of providing saturable absorber modulation to the resonant cavity through the two-dimensional semiconductor thin film 101 or 102, to realize the self-starting of the pulse laser, and then the pulse laser is output through the optical coupler 2 and the optical isolator 6.

Specifically, the optical fiber grating 4 may be a fiber Bragg grating or a chirped fiber grating, which has a high transmission rate for the pump light and a certain reflection rate for the laser, and the reflection rate may be in a range of 10-99%. The optical fiber grating acts as a fiber-typed mirror to provide feedback to the light, which forms the resonant cavity of the laser together with the saturable absorber mirror. The active optical fiber is the gaining medium of the laser.

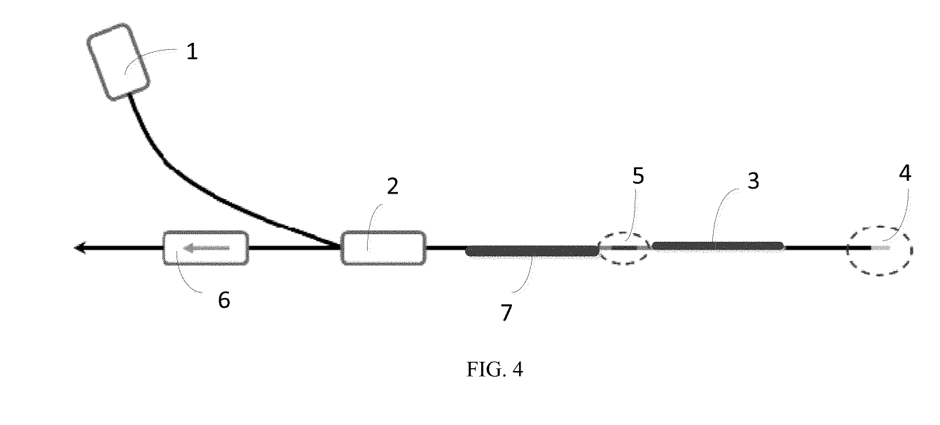

Referring to FIG. 4, a pulse fiber laser with amplifying function is provided according to the embodiments of the present disclosure. The pulse fiber laser comprises a semiconductor pump laser 1, an optical coupler 2, a resonant cavity, and an amplifier 7. The resonant cavity has a linear cavity structure, which comprises a high-gain active optical fiber 3, the two-dimensional semiconductor saturable absorber mirror 4 mentioned above, and an optical fiber grating 5. The components of the amplifier 7 are high-gain active optical fibers. Specifically, the optical fiber grating 5 may be a fiber Bragg grating or a chirped fiber grating, which has a high transmission rate for the pump light and a certain reflection rate for the laser, and the reflection rate may be in a range of 10-99%. The optical fiber grating 5 is directly wrote on the high-gain active optical fiber 3, one side of the optical fiber grating 5 is the high-gain active optical fiber 3 in the resonant cavity, and the other side of the optical fiber grating 5 is the high-gain active optical fiber of the amplifier 7. The optical isolator 6 is capable of preventing the feedback of the pulse laser.

The pulse fiber laser has the advantages of full utilization of fiber, high reliability and so on, which is suitable for the achievements transformation and has a wide application prospect.

The aforementioned is only the preferred embodiments of the present disclosure, which should not be understood as limitations to present invention. Any modification, equivalent, and improvement made within the spirit and principle of the present invention falls into the scope of the present invention.

We claim:

1. A two-dimensional semiconductor saturable absorber mirror, comprising an optical fiber, a two-dimensional semiconductor thin film attached to an end surface of the optical fiber, and a gold film attached to the two-dimensional semiconductor thin film.

2. The two-dimensional semiconductor saturable absorber mirror of claim 1, wherein the optical fiber is a single-mode fiber, a polarization-maintaining fiber, a high-gain active optical fiber, or an active ZBLAN fiber.

3. The two-dimensional semiconductor saturable absorber mirror of claim 1, wherein the two-dimensional semiconductor thin film is made of any one or two materials selected from copper sulfide, gallium selenide, gallium telluride, gallium sulfide, germanium selenide, tungsten ditelluride, molybdenum ditelluride, hafnium disulfide, hafnium diselenide, cobalt diselenide, cobalt ditelluride, rhenium diselenide, rhenium ditelluride, tin disulfide, tin diselenide, niobium disulfide, niobium diselenide, titanium disulfide, titanium diselenium, tantalum disulfide, tantalum diselenide, zirconium disulfide, zirconium ditelluride, bismuth sulfide, bismuth selenide, and bismuth telluride.

4. The two-dimensional semiconductor saturable absorber mirror of claim 3, wherein the two-dimensional semiconductor thin film is made of two materials, and is a heterojunction superlattice with the two materials alternatively growing.

5. The two-dimensional semiconductor saturable absorber mirror of claim 1, wherein a thickness of the gold film is 500-1000 nm.

6. A method for fabricating the two-dimensional semiconductor saturable absorber mirror of claim 1, comprising the following steps:
cutting the optical fiber;
putting the cut optical fiber and a two-dimensional semiconductor target into a vacuum chamber, ionizing a surface of two-dimensional semiconductor target to generate two-dimensional semiconductor plasma, depositing the two-dimensional semiconductor plasma on an exposed end surface of the optical fiber to form the two-dimensional semiconductor thin film, and by controlling deposition time and/or deposition temperature, ensuring the two-dimensional semiconductor thin film to be a desired thickness; and
plating the gold film on the resulting two-dimensional semi-conductor thin film.

7. A pulse fiber laser comprising a semiconductor pump laser, an optical coupler, and a resonant cavity; wherein pump light produced by the semiconductor pump laser enters the resonant cavity through the optical coupler, the two-dimensional semiconductor saturable absorber mirror of claim 1 is provide in the resonant cavity, and the two-dimensional semiconductor saturable absorber mirror is configured to modulate the light in the resonant cavity to produce pulse laser.

8. The pulse fiber laser of claim 7, wherein an active optical fiber and an optical fiber grating are further provided in the resonant cavity; the pump light enters the resonant cavity through the optical coupler to provide gain to the active optical fiber, thus laser is produced by the resonant cavity; then the laser is modulated by the two-dimensional semiconductor saturable absorber mirror, and is resonated in the resonant cavity to produce the pulse laser.

9. The pulse fiber laser of claim 8 further comprising an amplifier and an optical isolator, wherein the produced pulse laser is amplified by the amplifier and then passes through the optical coupler and the optical isolator to output a final pulse laser.

10. The pulse fiber laser of claim 8, wherein the optical fiber grating is a fiber Bragg grating or a chirped fiber grating.
